(19) United States
(12) Patent Application Publication
(10) Pub. No.: US 2012/0159818 A1
(43) Pub. Date: Jun. 28, 2012

(54) METHOD AND APPARATUS FOR PROVIDING A SIMULATED NEON SIGN

(76) Inventor: Andy K. F. Kaoh, Santa Ana, CA (US)

(21) Appl. No.: 13/391,810

(22) PCT Filed: Aug. 28, 2009
(86) PCT No.: PCT/US09/55234

§ 371 Date: Mar. 19, 2012

Related U.S. Application Data
(63) Continuation-in-part of application No. 29/332,476, filed on Feb. 17, 2009, now Pat. No. D599410.

(51) Int. Cl. G09F 13/04; B29C 31/08

(52) U.S. Cl. 40/541; 264/294

(57) ABSTRACT

A lighting apparatus for simulating a neon sign and method of making is provided. An outer housing having a central opening and defining a perimeter of the lighting apparatus can be connected with an inner housing configured as a plurality of symbols for conveying a message. Mounted within the interior of the outer and inner housing can be a series of lighting units such as SMD light emitting diodes. Respective outer housing and inner housing can have a cross-sectional inverted U-shape capped by a base member with the upper member having a curved diffuser for transmitting light through a transmissive plastic resin while integrally mounted black or opaque straight legs of a U-shape can enhance the simulated neon glow.

### CROSS-REFERENCE TO RELATED APPLICATION

This is a continuation in part application of U.S. Design patent application Ser. No. 29/332,476 filed Feb. 17, 2009.

### BACKGROUND OF THE INVENTION

1. Field of the Invention

The present invention relates to a lighting device and more particularly, signage devices that can simulate the appearance of a neon gas sign without the cost or possibility of breakage of a conventional neon gas sign.

2. Description of Related Art

Conventional establishments such as retail outlets, restaurants and convenience stores have made extensive use of neon light signs to convey a commercial message and the appearance of such neon light signs have become acceptable to customers. Bright, uniform and colorful light distribution emanated from a neon light medium will attract attention and can be subjectively configured to provide an attractive advertising medium. Neon light signs, however, are fragile and are usually shaped by an artisan by applying heat to lead glass tubing to provide a desired shape. The indicia symbols of a neon sign are then assembled into a single structure and electrically coupled to electrodes with a stepped up voltage from a conventional source to somewhere between 3000 to 15,000 volts. The interior of the glass tubing is coated with phosphor that can react to ultraviolet light and emit colored light in a visible spectrum. A neon tube is also provided with one or more noble gases such as neon, krypton, xenon, argon or helium which, when subject to a large voltage, can generate an arc that creates ultraviolet light that can cause the phosphor to appropriately glow.

U.S. Pat. No. 7,467,486 recognized a desire to provide an alternative to a neon sign that can be manufactured in a less expensive manner while providing a lightweight, safe and less fragile signage while also removing the problems associated with hazardous waste.

However, there is still a need in the prior art to provide an improved simulated neon sign that more closely approximates the appearance of an actual neon sign in an economical manner with improved luminous characteristics.

### SUMMARY OF THE INVENTION

The present invention provides a lighting apparatus for simulating a neon sign that can comprise an outer housing having a central opening for defining a perimeter for the lighting apparatus. An inner housing can be configured to provide a plurality of symbols or characters with open spaces adjacent and between the symbols. The inner housing symbols can be interconnected together and also connected at opposite ends to the outer housing so that the symbols can extend across the central opening within the perimeter to provide indicia simulating a neon tube configured to provide a message suspended within the outer housing.

A lighting unit can be mounted within the inner housing and/or the outer housing to provide illumination. The lighting unit can include light emitting diodes (LED) or alternative lighting units that can be mounted within the inner and/or outer housing to transmit light through a curved transmission portion of the respective inner and outer housings. Conventional light emitting diodes can also be used as one source of light and an alternative source of light can be a surface mounted device which is smaller than a conventional LED, and is known as SMD LED's.

The outer housing and the inner housing can be molded together as a unitary structure from a plastic resin. An upper housing assembly is configured to provide a plurality of symbols with open spaces adjacent and between the symbols. The upper housing assembly can have a cross sectional configuration of a pair of spaced side walls of an opaque or black plastic that is initially introduced into a mold and solidified and subsequently a light transmissive curved upper surface portion is integrally connected to the opaque plastic of the spaced side walls in the same mold to collectively form in a cross sectional view, from the bottom to the top of the upper housing, of an approximately inverted U-shape.

The inner and outer housing also includes a base member that can be molded and configured to match both the outer and inner housing configuration and to engage the open ends of the inverted U-shaped spaced side walls. The light transmissive curved upper surface portion can have an approximately semicircular cross section to simulate a neon tube for an illumination effect and to define the plurality of symbols. Alternatively, a variation in cross-sectional thickness of the upper surface can provide a different spreading of light rays. This light transmission curved upper surface portion can perform as a cylindrical lens for transmitting light from the lighting unit, which provides a principal optical ray extending normal to the center of the semicircular cross section of the curved upper surface portion. The cylindrical lens can transmit some of the light from the lighting unit to either side of the curved upper surface portion to enhance a neon tube effect.

To obscure the appearance of the lighting unit through the light transmissive curved upper surface portion, known as a hot spot, a filler material of small particles can be added to a clear polymethyl methacrylate (PMMA) plastic resin, such as a filler material of a vitriolic barium. Barium is a silver white alkaline earth metal and when subject to an appropriate acid treatment, can produce a white precipitate of barium sulfate. When added as a filler material of an appropriate size and amount to the plastic resin, the light rays can be scattered where the direction of the light is altered by reflection and/or refraction, and also diffraction so that a redistribution of the rays is created by contact with the small filler particles.

Alternatively, light transmission spherical particles of a different index of refraction from that of the light transmissive curved plastic resin can also be used to improve light scattering characteristics. For example, a polymer based diffusion compound formulated for an acrylic clear plastic can also be used to eliminate the hot spots that could be caused, for example, by an LED in an application such as signage. Spherical polymer particles can scatter and spread light to provide an even illumination while allowing light transmission levels of 90% or more.

Preferably the physical size of support connections, for structural purposes between the outer housing and the inner housing, are minimized while providing adequate strength, thereby optimizing the appearance of a conventional neon tube sign. Such connections can be rectangular, tubular hollow members that can be molded.

To minimize the components that must be assembled to create the lighting apparatus for simulating a neon sign, an upper member housing that forms the inverted U-shape can be molded in a two part procedure wherein initially the side legs of the upper member and flat upper surfaces of connection portions are molded from an acrylonitrile-butadiene-styrene (ABS) co-polymer which is a thermal setting resin that can provide an opaque or black appearance. Subsequently, a light transmissive curved upper surface can also be integrally molded with an appropriate light scattering filler material that can be combined with the opaque side walls. A clear polymethyl methacrylate with appropriate filler material can be utilized to permit the curved portion of the U-shaped upper housing to simulate a neon tube while obscuring any hot spots or appearance of the light source.

The lower base member can also be formed of the same ABS thermal setting plastic resin and can be configured to engaged the open ends of the space side walls. The base member can further be configured to be molded with spacing pads supporting a substrate such as a printed circuit board upon which lighting units can be mounted. The base member can be snapped on to the upper member and permanently secured with screws or other fasteners.

In the method of manufacturing, a common lower half mold can be used for initially receiving the ABS plastic of an opaque or black color to form the legs of the inverted U-shaped upper housing. Subsequently, when the legs have been formed, another mold half can be applied to the same lower mold and a PMMA plastic with an appropriate scattering filler can be inserted into the mold set to form the curved light transmissive portion which will set up integral with the opaque side walls.

A separate mold can be utilized to provide the base member having a configuration that will complement and match the upper housing member to form the lighting device housing. Prongs can be provided on one of the upper housing and base member for snapping into appropriate complementary indentations to facilitate an initial snap mounting of the two parts after the printed circuit board supporting the light unit, such as LED's, light control switches and control circuits have been assembled into the base member

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a front elevated view of a first embodiment of our lighting apparatus;

FIG. 2 is a rear elevated view of FIG. 1;

FIG. 3 is a top view of the first embodiment;

FIG. 4 is a bottom view of the first embodiment;

FIG. 5 is a left side elevated view of the first embodiment;

FIG. 6 is a right side elevated view of the first embodiment;

FIG. 7 is a perspective view of a second embodiment;

FIG. 8 is a front elevated view of a third embodiment of the present invention;

FIG. 9 is a rear elevated view of the third embodiment of the present invention;

FIG. 10 is a perspective view of the third embodiment of the present invention;

FIG. 11 is a perspective rear view of the third embodiment of the present invention;

FIG. 12 is a perspective exploded view of the third embodiment of the present invention;

FIG. 13 is a cross-sectional view of the third embodiment of the present invention;

FIG. 14 is a schematic cross-sectional view of a first molding step for forming the upper housing;

FIG. 15 is a cross-sectional view of the second molding step for forming the upper housing;

FIG. 16 is a schematic illustration of light scattering diffusion particles in the light transmissive portion of the housing to illustrate the random distribution of light rays; and

FIG. 17 is a graph of the radiation angle and intensity of an SMD LED.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

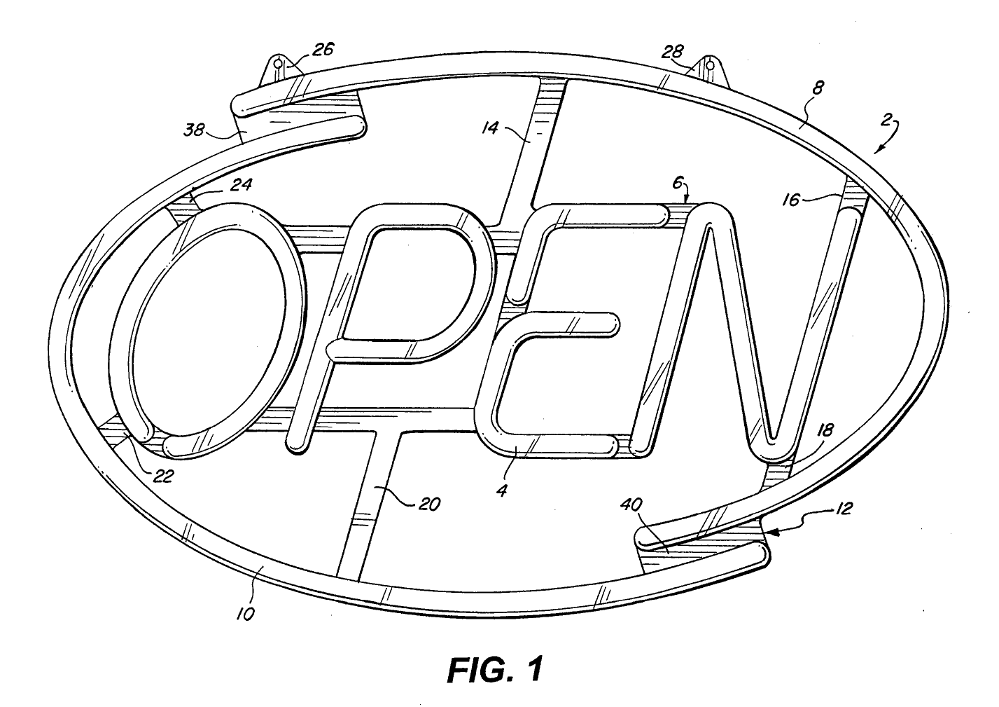

Referring to FIG. 1, a first embodiment of the present invention is disclosed in a lighting assembly 2 capable of simulating a neon sign. Symbols are arranged as indicia to convey a message. In this regard, alphabetic characters are defined by light transmissive areas simulating neon tubes to spell OPEN. Accentuating the sign message are a pair of open curved members of a light transmissive nature to also simulate neon tubes. The symbols of letters 4 are mounted on an inner housing 6.

Encircling the inner housing 6 are a pair of curved light transmissive portions 8 and 10 on an outer housing 12 that forms a perimeter around the inner housing 6. Support members 14, 16, 18, 20, 22, and 24 having a hollow rectangular cross-sectional configuration interconnect the inner housing 6 with the outer housing 12. The support members are preferably molded and formed from an opaque or black resin material that approximate the thickness of the symbols 4 and the respective curved light transmissive portions 8 and 10.

As can be seen in FIG. 1, the inner housing 6 also provides a supportive lattice work for the symbols 4 that extend across a central opening in the outer housing 12. When the light assembly 2 is lit, the central open “see through” portion of the outer housing accentuates the neon tube appearance of the letters 4 and the outer curved light transmissive portions 8 and 10. The dark colored or black appearance of the support members are not readily seen, especially from a distance and in a nighttime environment. Projections 26 and 28 on the upper surface of the outer housing 12 can have apertures to facilitate hanging the lighting assembly 2 in an appropriate display position.

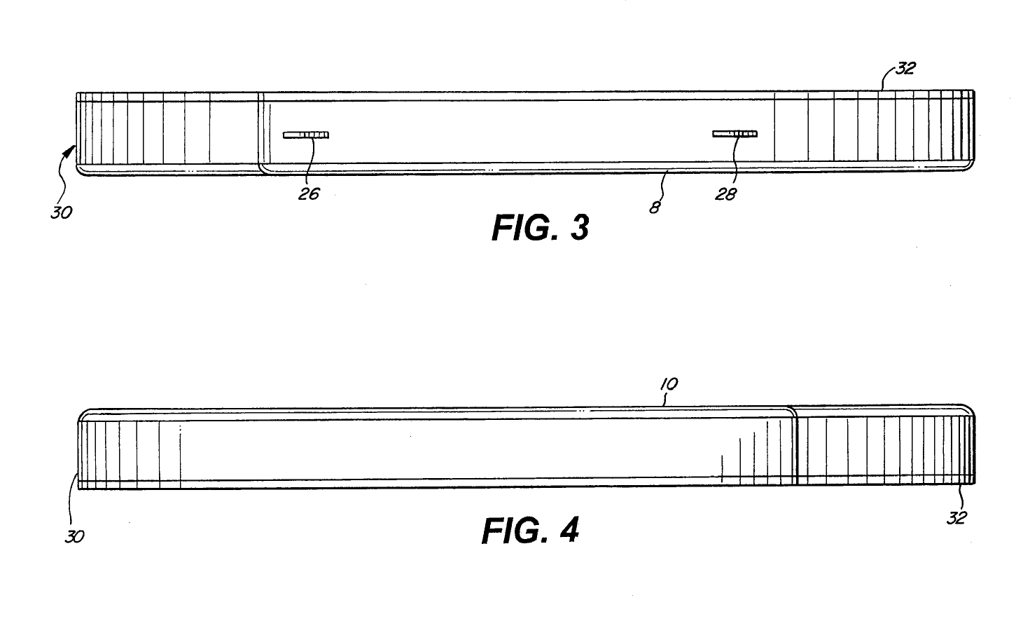

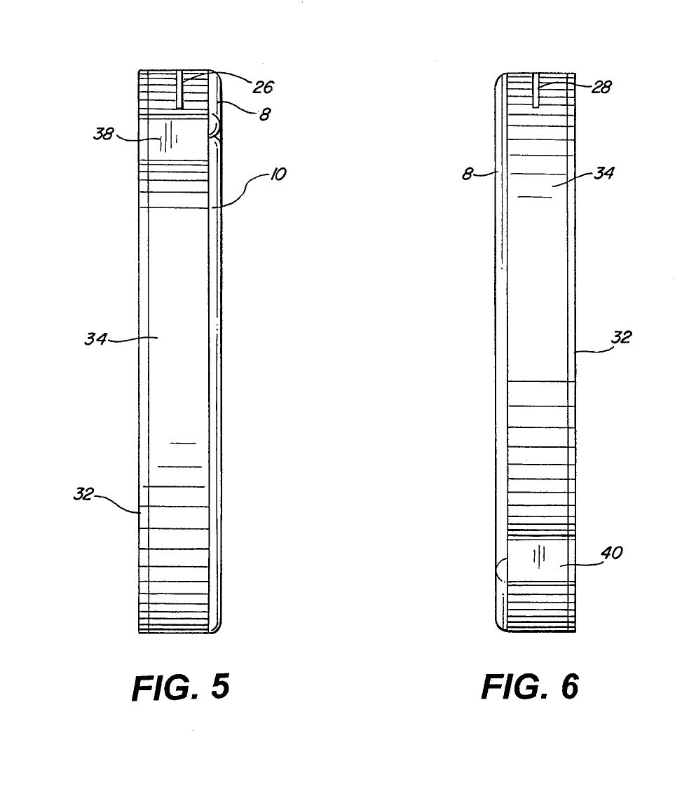

Referring to FIGS. 3-6, the relatively thin compact shape of our lighting assembly 2 can be appreciated.

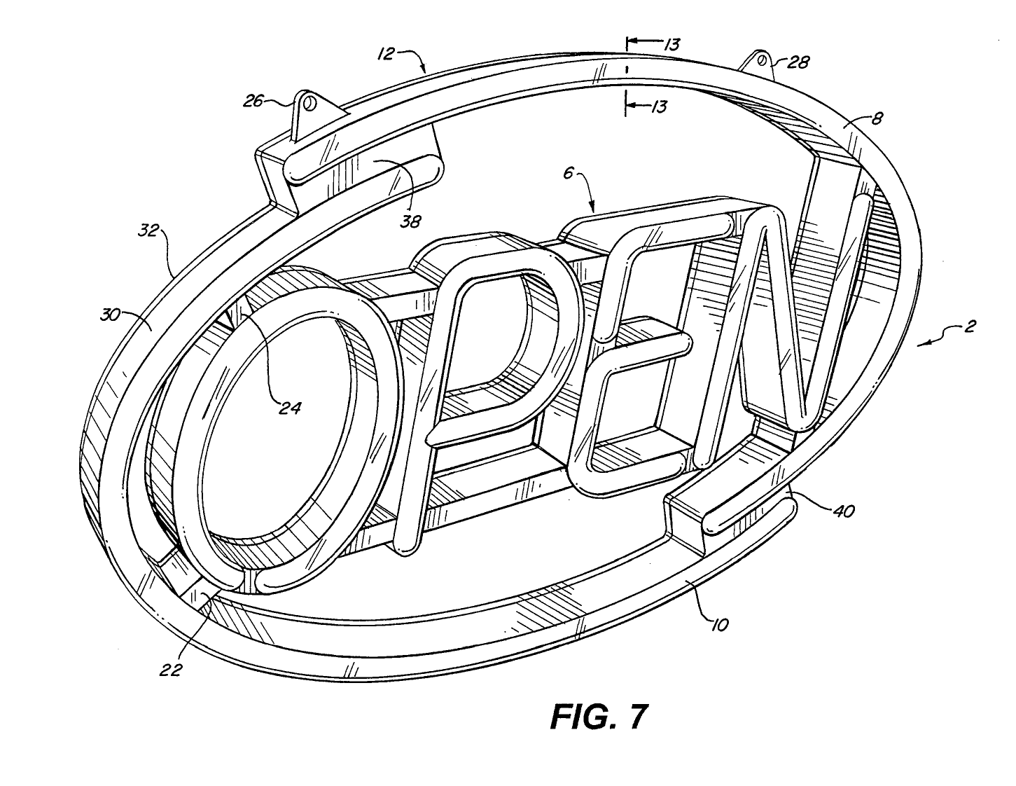

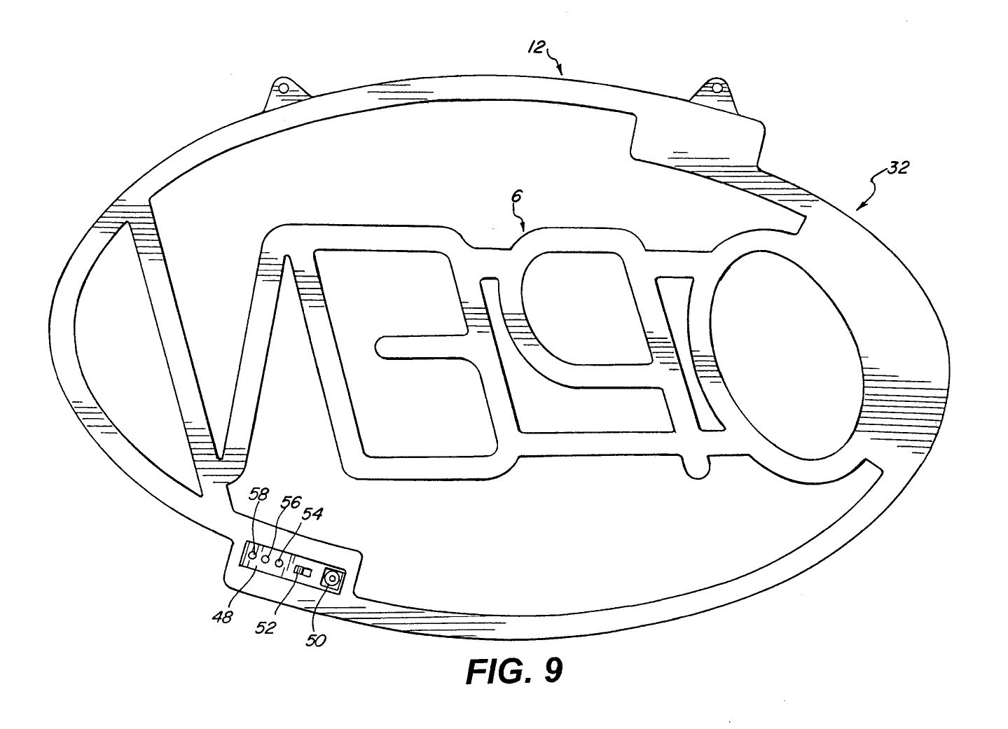

Referring to FIG. 7, a perspective view of a second embodiment is disclosed that is a variation of the first embodiment with support members 14 and 20 removed. FIG. 9 discloses the base member 32 for the second embodiment.

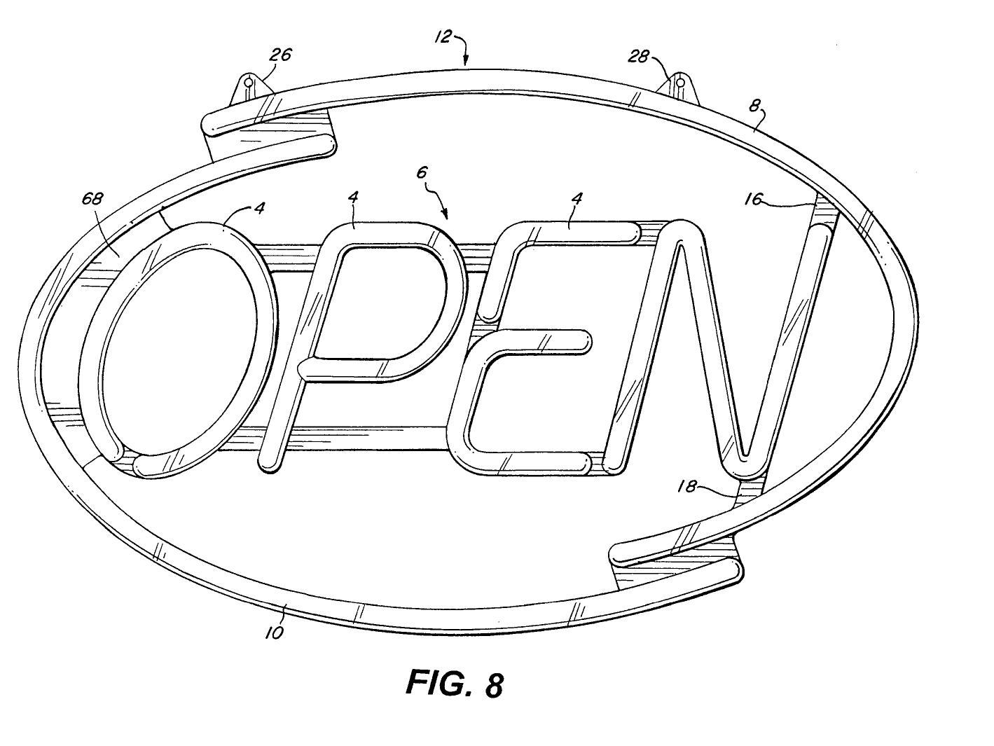

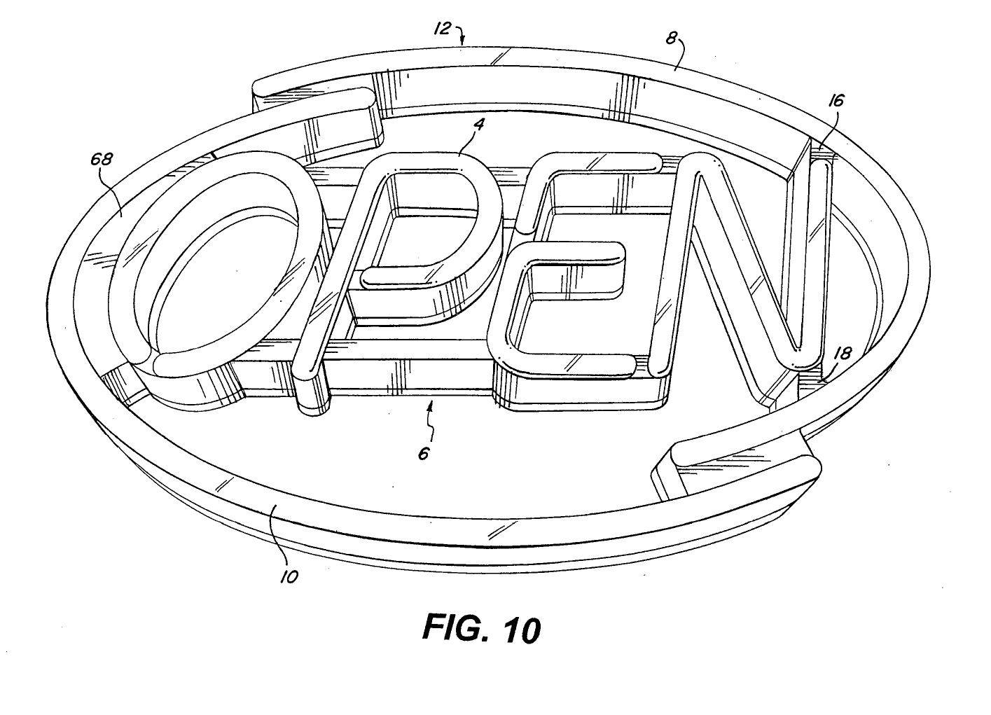

FIGS. 8-12 disclose a third embodiment and common elements that are utilized in the drawings for FIG. 1 are repeated in these views.

The major difference is that the signage is only supported at either end, within the central opening of the outer housing 12 to support members 16 and 18 and elongated support member 68.

As can be appreciated, in the third embodiment, the elongated support member 68 adjacent the O letter could be replaced with the smaller support members 24 and 22 shown in FIG. 7.

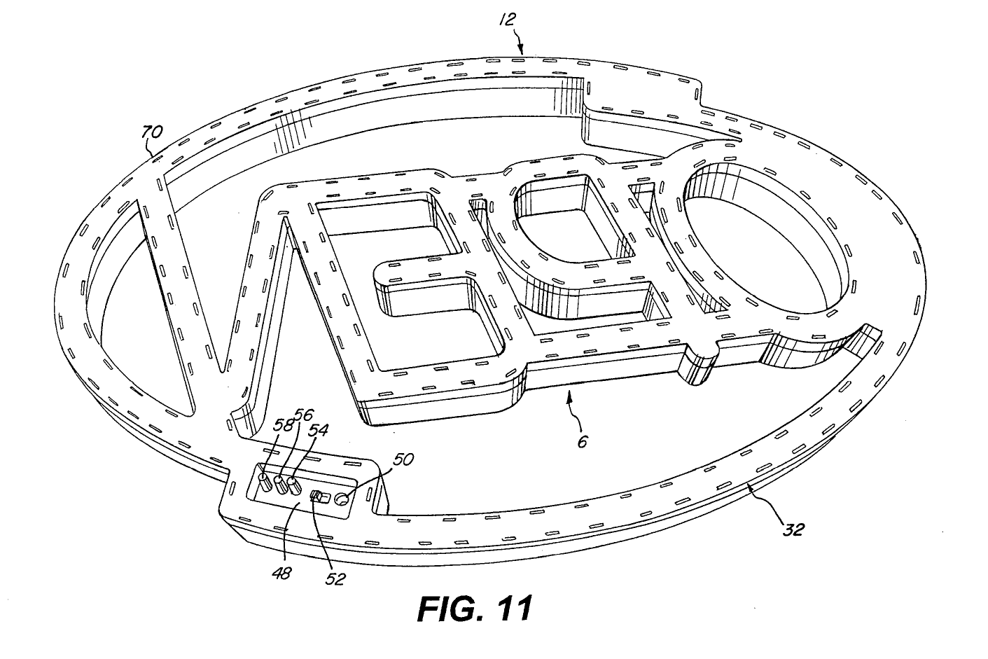

As seen in FIG. 11, a plurality of open slots 70 can be provided in the base member 32 to provide ventilation for the release of heat generated by the LED's.

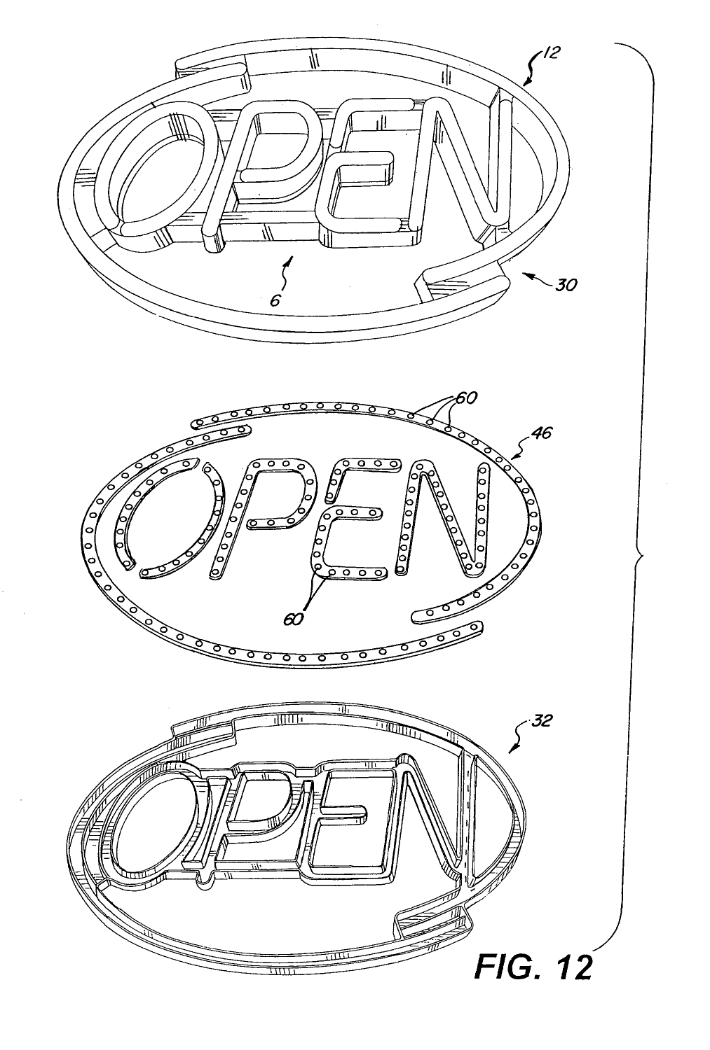

Referring to FIG. 12, the base member 32 represents basically a minor image of the back side of upper member 30 so that the cavity openings, that receive the elongated strips of printed circuit board substrates supporting the individual SMD LED 60, are isolated to prevent any light pollution between the individual channels.

The construction of the light assembly 2 housing can be appreciated, particularly when taken in context from the perspective exploded view of FIG. 12. The inner housing 6 and the outer housing 12 are integrally molded together and are formed by an upper member 30 and a lower base member 32.

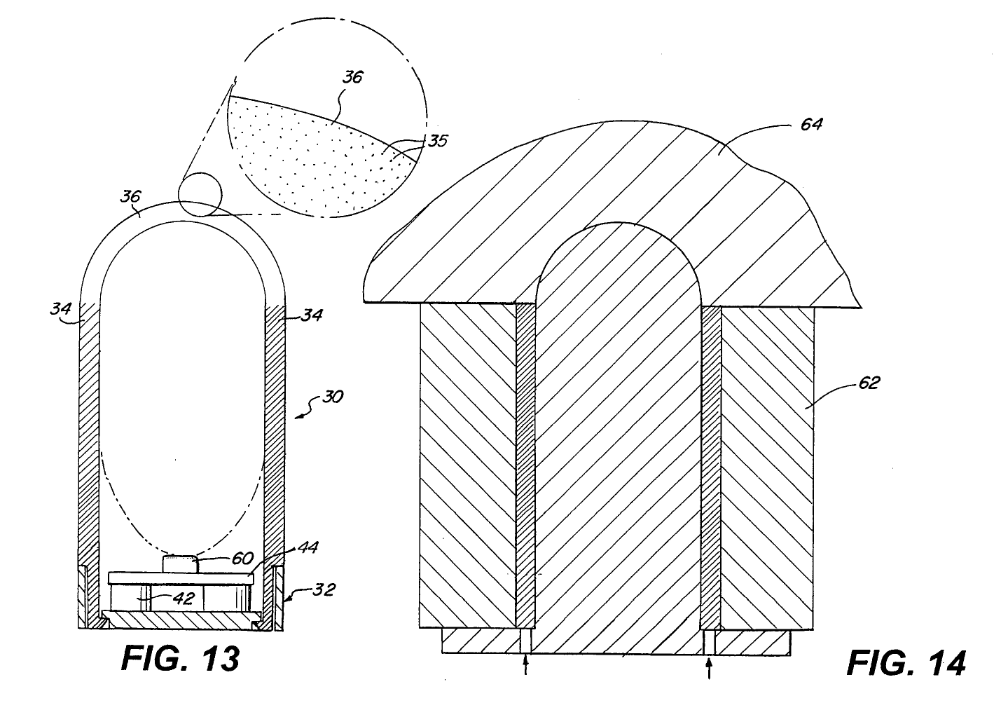

The upper member 30 has a cross-sectional inverted U-shape as can be seen in FIG. 13 that includes side walls 34 of an opaque or black color and a light transmissive curved portion 36. The light transmissive curved portion 36 forms approximately half of a circle and FIG. 13 is representative of an upper member for both the inner housing and the outer housing with the curved portion 36 providing a simulation of the neon tube. The upper surface of both the inner housing 6 and the outer housing 12 provides a simulation of a neon tube with the curved portion 36, otherwise they have a flat surface of an opaque or black coloration. For example, the upper support members 14-24 and the interconnect supports 38 and 40 between the inner housing 6 and the outer housing 12 have an upper flat black surface.

The base member 32 as shown in FIG. 13 can be snap fitted onto the lower ends of the side walls 34 of the upper member 30. While not shown, screws can be utilized to further interconnect the upper member 30 with the base member 32. The base member 32 forms a relatively shallow cap and includes supports or space pedestals 42 for a printed circuit substrate of an elongated narrow configuration 44 that can directly mount light emitting diodes (LED's) to form the lighting unit 46.

By using a combination of red, green and blue LED's, it is possible to drive the relative luminous intensities of the respective LED's to create a bright white light. Alternatively, different variations of color can be created by selectively activating the specific red, green or blue LED's. For example, in the display signage of our respective embodiments, the curved light transmissive portions 8 and 10 can be appropriately driven to provide a blue or red constant light or a flashing color while the curved portions 36 of the symbols or letters 4 could provide a white light with an appropriate driving of each of the red, green and blue LED's. While other lighting sources can be contemplated and used in the present invention, LED's are relatively lightweight and sturdy and can be driven with a DC power that can be converted from a conventional AC 120V power source.

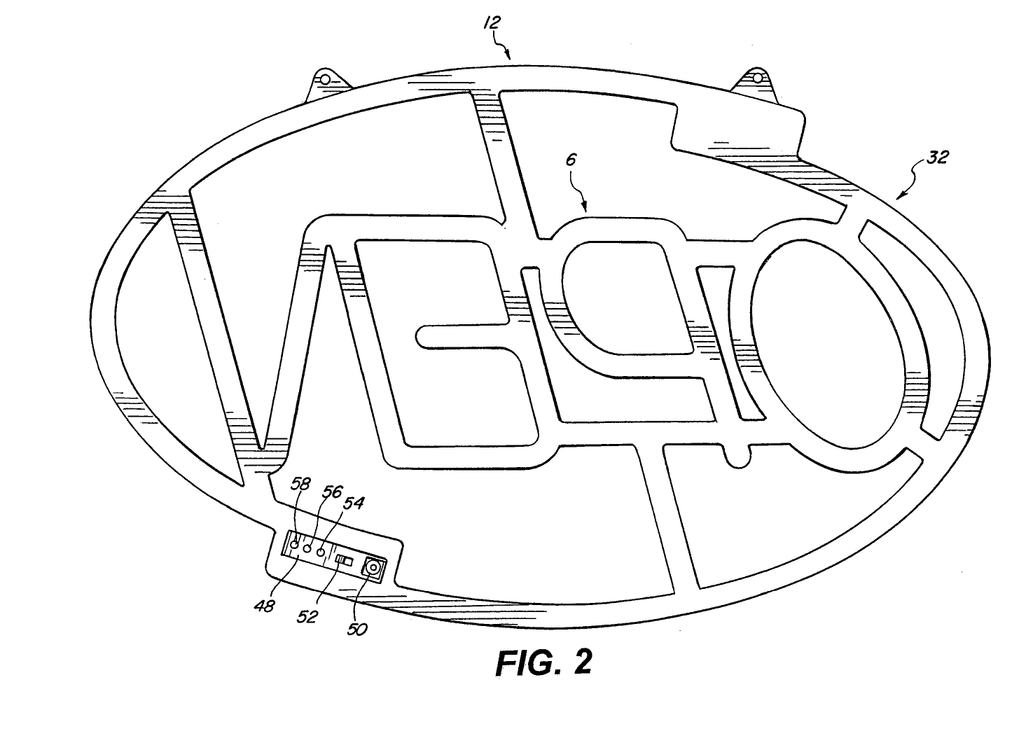

As seen in FIG. 2, an operator control panel 48 has a power port 50 for receiving a plug in jack to provide a source of DC power (not shown). A static or flash switch 52 is positioned next to the jack 50 and a series of switches or buttons such as a color switch 54 can change the color from blue, red, green, white, purple and yellow of the lower tube 10. The color switch 56 can alter the same six colors on the upper tube 8 while the color switch 58 can alter the same six colors on the indicia of the inner housing 6. Optionally, the switch 52 can also vary the flash rate of the sign illumination. Thus, an operator input can change and vary the individual colors of light transmitted through the various inner and outer housing portions of the sign. As can be appreciated, various visual effects could also be incorporated into the sign with controls implemented by a micro computer that can be pre-programmed and subsequently changed by a downloading of additional control instructions to provide a variety of visual effects such as sequencing, dimming, auto start and auto shutdown which can be implemented.

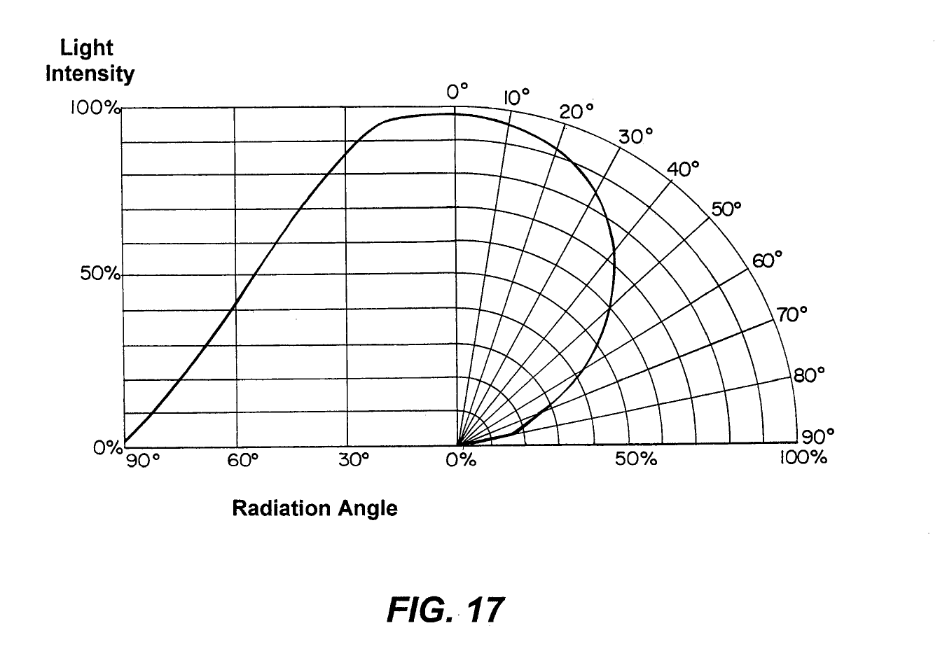

In a preferred embodiment, a surface mounted device (SMD) LED can be utilized. As seen in FIG. 13, SMD LED's 60 are disclosed mounted on a series of printed circuit board strip 44. The SMD LED 60 has the advantage of being of a very small dimension while providing a highly efficient bright light output. The light pattern provides a circular output of light intensity such as shown in FIG. 17. The SMD LED 60 has three LED's of red, green and blue mounted within a concave portion of its housing. The individual LED's can be separately driven to provide not only a white light but also at least five other colors.

Referring to FIG. 17 most of the light intensity can be realized on the optical axis which extends normal to the light transmissive curved portion 36. As can be appreciated, the light can reflect from the internal surface of the side walls 34 and the side walls can be manufactured in a smooth fashion to assist reflection of the light rays through the curved portion 36. The curved portion 36 also can spread the light laterally to assist in a glow effect for simulating a neon tube. Note, the curved portion can have other shapes to assist in spreading the light to simulate a neon tube.

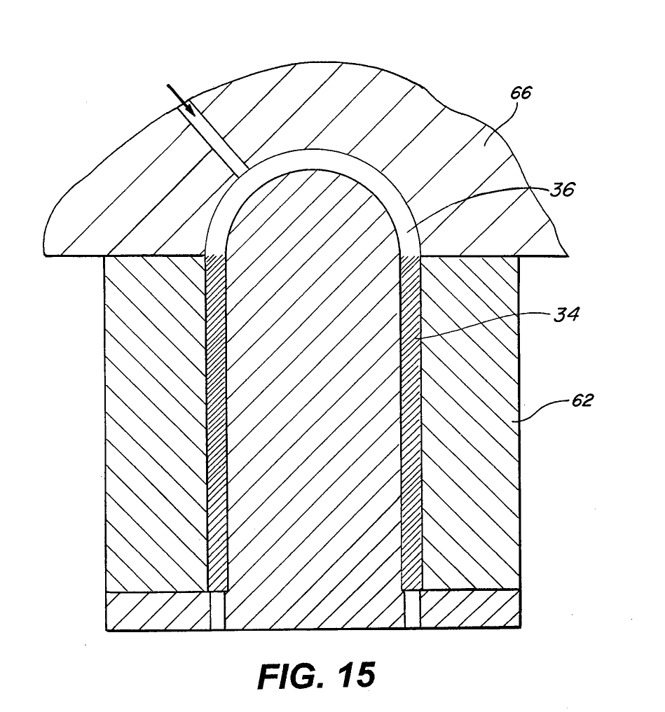

The side walls 34 can be injection molded with a set of molds as shown in FIGS. 14 and 15. A lower female mold half 62 can be capped with a first upper mold half 64 and then ABS plastic of an appropriate color, such as Polylac™ from the Chi Mei Corporation of Taiwan can be utilized. Subsequently, as shown in FIG. 15, a second upper mold half 66 can replace the first upper mold half 64 after an appropriate period or permitting a setting of the ABS plastic for a side wall 34, while still in the lower mold half 62.

The second upper mold half 66 can be mounted to create a cavity having the desired curved light transmissive portion 36 and a PMMA thermal setting plastic resin such as Acryrexx™ available from the Chi Mei Corporation of Taiwan, with a mixed additive filler material that will scatter and diffuse light, is injected into the mold. As a result, the U-shaped inverted upper member 30 can be integrally formed as shown in FIG. 13. The filler particles 35 can remove hot spots to remove any appearance of the individual SMD LED's that would otherwise be apparent to an observer.

For example, a mineral filler particle like a vitriolic barium having a mesh size of 300 and constituting an approximate 5% wt. of the acrylic PMMA can be added. Barium sulfate is a white pigment powder that can be used as a filler in plastic and can act as a diffuser for a light source. The particle size is approximately 50 microns and it is believed that reflection off of the particles provide the primary source of scattering.

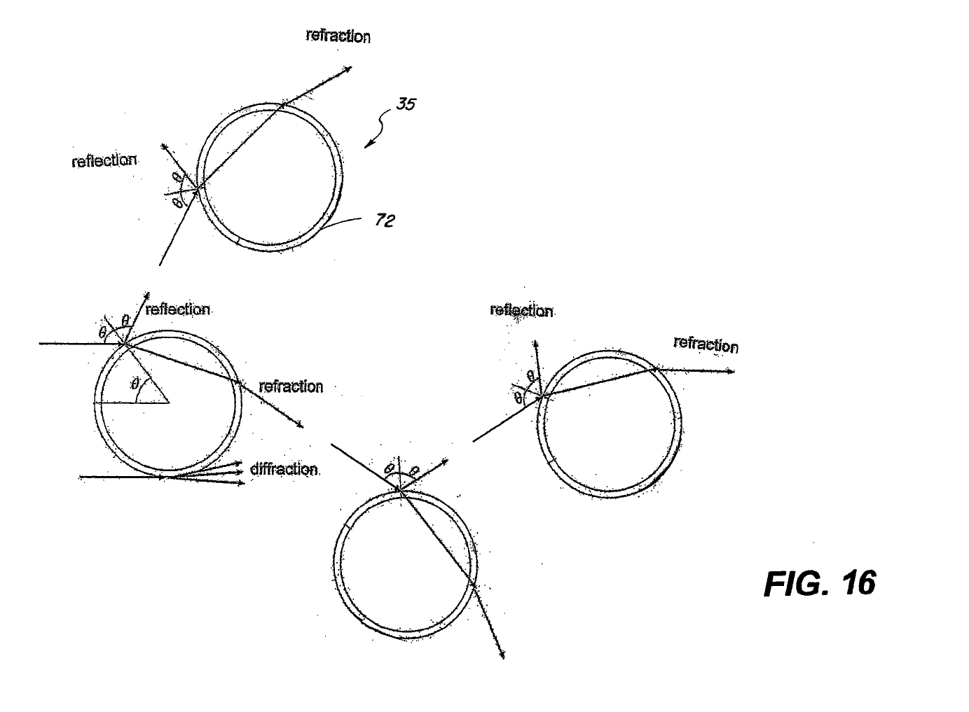

Referring to FIG. 16, a schematic illustration is provided for disclosing reflection off the exterior of filler particles. As can be appreciated, this is a simplified schematic illustration with only one ray since the incidence of rays on the individual particles will vary as the light ranges contact different surfaces at different incident angles to be is sent off in different directions.

Alternatively, it is believed that the use of transparent filler particles, for example an aluminum silicate of 325 mesh glass powder of approximately 44 microns in diameter, having an index of refraction different from that of PMMA plastic, can be utilized in an amount of 6 to 10% wt. to increase the forward light transmission since the light traveling through individual particles and subject to refraction as seen in FIG. 16 would have a more forward directional light transmission and thereby increasing the total light transmission.

A use of a conventional anti-reflective coating 72 on the particles 35 may further increase the transmissivity of the total light from the LED's. A proper balance between weight by percentage of the filler particles and the overall weight of the light transmissive PMMA plastic can eliminate a hot spot problem. As shown in FIG. 16, as the particles become much smaller, an issue of diffraction can also occur, but it is believed that particles of approximately 44 microns can principally experience reflection and refraction.

As can be appreciated from FIG. 16, there is a randomness in the direction and scattering of the light to thereby obscure any visualized image of the light source on the viewer side of our lighting assembly. The randomness results from the initial mixing of the filler particles with the PMMA resin prior to molding which has an inherent uncontrolled positioning of the particles in the cured plastic.

The general principles of such scattering of light by the filler particles embedded in the plastic can be found in Scattering Properties of Core-Shell Particles and Plastic Matrices by Small et al. published by Wiley Inter Science WWW.Interscience.Wiley.com, 2005 and incorporated herein by reference.

In theory, if a sufficient number of particles per unit volume are provided in the curved light transmissive portion 36 so that they are greater than a mean free path, then photons of light can be scattered multiple times in a random manner. By using a transparent particle with a different index of refraction than the PMMA plastic, the scattering will be a combination of reflection and refraction with the refraction tending to be more biased in a forward direction. Additionally, the use of an anti-reflecting coating 72 will also increase the bias in a forward direction by lessening the amount of reflection through the curved light transmissive portion 36 to provide a higher light transmission and a brighter sign.

FIG. 17 discloses a chart of radiation angle and light intensity for SMD LED 60. The LED's are combined in a single structure 60 and the light emitting diodes in a wavelength range of blue, green and red can collectively produce an intense white light source having this radiation angle distribution.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A lighting apparatus for simulating a neon sign comprising:
an outer housing having a central opening and defining a perimeter of the lighting apparatus;
an inner housing configured as a plurality of alphabetic letters interconnected together and connected at opposite ends to the outer housing wherein the alphabetic letters extend across the central opening within the perimeter and spaces within and adjacent the plurality of alphabetic letters are part of the central opening to provide indicia simulating a neon tube configured to provide the alphabetic letters suspended within the outer housing; and
a lighting unit mounted within the inner housing to illuminate the plurality of alphabetic letters.

2. The lighting apparatus of claim 1 wherein the alphabetic letters are formed by a light diffusing member to diffuse light transmitted by the lighting unit.

3. The lighting apparatus of claim 1 wherein the inner housing has an upper member with a cross sectional inverted U-shape for forming the alphabetic letters with a curved diffuse transmitting light from the lighting and to simulate a neon effect.

4. The lighting apparatus of claim 3 wherein the inner housing includes a base member for supporting the lighting unit and configured to match and close the inverted U-shape member.

5. The lighting apparatus of claim 4 wherein one of the upper member and the base member has alignment extensions and the other of the upper member and the base member has alignment apertures for receiving the alignment extensions.

6. The lighting apparatus of claim 3 wherein the upper member cross sectional inverted U-shape has the curved diffuser for transmitting light of a transmissive plastic resin at the curved portion and the straight legs of the U-shape are integrally formed and connected to the transmissive plastic resin with an opaque plastic resin.

7. A light apparatus for simulating a neon sign comprising:
an upper housing assembly configured to provide a plurality of symbols with open spaces adjacent and between the symbols, the upper housing assembly having a cross sectional configuration of a pair of spaced side walls of an opaque plastic and a light transmissive curved upper surface portion integrally connected to the opaque plastic of the spaced side walls to collectively form, in the cross sectional view, from the bottom to the top of the upper housing, an approximately inverted U-shape;
a base member configured to engage the open ends of the spaced side walls; and
a lighting unit mounted within the base member and the upper housing to provide light for transmission through the curved upper surface.

8. The light apparatus of claim 7 wherein the curved upper surface portion has an approximately semi-circular cross section to simulate a neon tube illumination effect and define the plurality of symbols.

9. The lighting apparatus of claim 8 wherein the lighting unit includes a plurality of light emitting diodes (LED's) for transmitting light through the light transmissive curved upper surface portion.

10. The lighting apparatus of claim 8 wherein the light transmission curved upper surface portion optically performs as a cylindrical lens for transmitting some of the light from the lighting unit to either side of the curved upper surface portion.

11. The lighting apparatus of claim 10 wherein the curved upper surface portion includes a filler material of small particles to cause a diffraction of light rays from the lighting unit to redistribute the light rays following incidence upon the particles to enhance the simulated neon glow effect.

12. The lighting apparatus of claim 7 wherein the upper lighting assembly includes an outer housing having a central opening and defining a perimeter of the lighting apparatus and an inner housing defining the symbols, the inner housing symbols are interconnected for support and the inner housing extends across the central opening and is connected to only opposite sides of the outer housing to enable the symbols to be suspended across the central opening within the perimeter and spaces within and adjacent the symbols as part of the central opening to provide indicia simulating a neon tube configured to provide the symbols suspended within the outer housing assembly.

13. A method of forming a simulated neon sign, the improvement of:
molding a pair of spaced walls from an opaque plastic in a lower mold member;
providing an upper mold member that is configured to provide a curved surface interlinking the spaced walls;
molding a curved light transmissive plastic with diffuser material for scattering light rays to be integrally connected to the spaced walls;
inserting light emitting diodes between the spaced walls; and
sealing the spaced walls together to provide an inverted U-shape housing with the curved light transmission portion transmitting light from the light emitting diodes to simulate a neon tube.

14. The method of forming a simulated neon sign of claim 13 wherein surface mounted light emitting diodes capable of providing white and five other colors are mounted between the spaced walls.
